(19) United States
(12) Patent Application Publication
(10) Pub. No.: US 2022/0038190 A1
(43) Pub. Date: Feb. 3, 2022

(54) UNDERWATER COMMUNICATION USING ELECTRONIC DEVICES

(71) Applicant: Apple Inc., Cupertino, CA (US)

(72) Inventors: Ross L. Jackson, San Francisco, CA (US); Colin M. Ely, Sunnyvale, CA (US); Jody Cintone Fu, San Francisco, CA (US); Erik G. de Jong, San Francisco, CA (US); Jayesh Nath, Milpitas, CA (US)

(21) Appl. No.: 16/945,385

(22) Filed: Jul. 31, 2020

(51) Int. Cl. H04B 11/00; H04B 13/02; H04W 4/14; H04W 76/16

(52) U.S. Cl. CPC H04B 11/00; H04W 76/16; H04W 4/14; H04B 13/02

(57) ABSTRACT

Methods and devices may be used to perform underwater communication using one or more electronic devices. The one or more electronic devices include a first wireless transceiver configured to transmit first wireless signals through an air medium with the first wireless signals not being conducive for transmission through a water medium. The one or more electronic devices also include a second wireless transceiver configured to transmit second wireless signals through water. The electronic devices detect whether at least one electronic device has been submerged, and in response to submersion, transmits at least some communication types from the second wireless transceiver rather than the second wireless transceiver.

### BACKGROUND

The present disclosure relates generally to wireless electronic devices, and more particularly, to using wireless electronic devices to perform peer-to-peer (P2P) underwater communication.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Transmitters and receivers, or when coupled together as part of a single unit, transceivers, are commonly included in various electronic devices, and particularly, mobile electronic devices such as, for example, phones (e.g., mobile and cellular phones, cordless phones, personal assistance devices), radios, wearable electronic devices (e.g., smartwatches, heartrate monitors, exercise wristbands), or any of various other handheld devices. Certain types of transceivers, known as wireless transceivers, may be used to generate and receive wireless signals to be transmitted and/or received by way of an antenna coupled to the transceiver. Specifically, the wireless transceiver is generally used to enable the mobile electronic devices to wirelessly communicate data over the air via a network channel (e.g., cellular network or internet network channels) to and from one or more external mobile electronic devices or other wireless electronic devices.

However, as it may be appreciated, within certain environments (e.g., underwater environments, underground environments, high-altitude environments, rural areas, and so forth) wireless electronic devices may not be able to connect to, for example, cellular networks and/or internet networks. Thus, the wireless electronic devices may not be able to communicate in such environments. Furthermore, wireless signals used in such networks may be unsuitable for traveling through water over distances used in common dive conditions. Instead, divers may generally communicate using hand signals or other visual communications while underwater. However, such communications require line of sight that may be difficult or impossible in certain conditions, such as dives in caves, dives in wreckage, rescue dives, dives at night, or other situations where line-of-sight (LoS) is difficult to maintain. Furthermore, a diver receiving the hand signals has to look at the diver making the hand signals. However, focusing on eye-to-eye contact for a diver receiving the communication may be dangerous in situations where the receiving diver needs to focus on the receiving diver's surroundings. Furthermore, visual communications using hand signals or other movements may vary from diver-to-diver, diver team to diver team, or may have other localizations of the signals that may cause a miscommunication between the diver making the hand signals and the receiving diver when relying on visual communication to make the communication.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Various embodiments of the present disclosure may be useful in performing communication in the absence of a cellular and/or internet network connection and/or transmission through a medium (e.g., water) that is not conducive to cellular or Wi-Fi signals. By way of example, an electronic device includes sonic (e.g., ultrasonic or infrasonic) and/or optical (e.g., green LED) communication mechanisms configured to transmit signals through the medium that is not conducive to cellular or Wi-Fi signals. The electronic device may include an internal or external transceiver used to transmit signals through the medium. Such communication mechanisms may be useful in search-and-rescue diving operations or any other operation where eye contact between different users (e.g., divers) may be impractical due to line-of-sight issues.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device including a transceiver, in accordance with an embodiment of the disclosure;

FIG. 2 is a front view of a hand-held device representing another embodiment of the electronic device of FIG. 1, in accordance with an embodiment of the disclosure;

FIG. 3 is a front view of another hand-held device representing another embodiment of the electronic device of FIG. 1, in accordance with an embodiment of the disclosure;

FIG. 4 is a front view and side view of a wearable electronic device representing another embodiment of the electronic device of FIG. 1, in accordance with an embodiment of the disclosure;

FIG. 5 is a front view of another wearable electronic device representing another embodiment of the electronic device of FIG. 1, in accordance with an embodiment of the disclosure;

FIG. 6 is a flow diagram of a process for using the electronic device of FIG. 1 using two transceivers for different communication types, in accordance with an embodiment of the disclosure;

FIG. 7 is an illustration of an underwater deployment of the electronic device of FIG. 1 communicating with an edge device, in accordance with an embodiment;

FIG. 8 is an illustration of an underwater deployment of the electronic device of FIG. 1 in a wireless mesh network communicating with an edge device, in accordance with an embodiment;

FIG. 9 is a block diagram of a translating device configured to receive data from the electronic device of FIG. 1 and transmit signals through water, in accordance with an embodiment;

FIG. 10 is an illustration of an edge device-to-edge device communication between two groups of divers using the electronic devices of FIG. 1, in accordance with an embodiment; and

FIG. 11 is an illustration of a sea vessel-to-device communication using the electronic device of FIG. 1, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure generally relate to underwater communication using an electronic device. As previously noted, line-of-sight (“LoS”) may be difficult/impossible to maintain during some underwater situations. To alleviate such LoS communication limitations, electronic devices may be used to display communications in a manner that the receiving diver may review at convenient times rather than merely when a communicating diver makes hand signals. However, underwater communication may be impractical/impossible over any reasonable distance using traditional through-air wireless communications (e.g., 802.15-based communication, 802.11-based communication, and the like) due to a water medium greatly reducing transmission distances using such wireless communication techniques. Instead, alternative techniques may be deployed. For instance, in addition or alternative to the through-air wireless communications, the electronic device(s) may utilize underwater communications techniques, such as sonic and/or optical communication techniques. Furthermore, the electronic device(s) may be used to communicate using the through-air wireless communications in a first mode (e.g., above-water mode) and through-water wireless communications in a second mode (e.g., underwater mode). Additionally or alternatively, the electronic device(s) of a user may provide a bridge from another personal electronic device (e.g., phone) of the user to a remote device (e.g., an electronic device of another user and/or a buoy providing a bridge to another network). For instance, the other electronic device may communicate with the electronic device using a short-distance through-air wireless communication that bridges to the remote device using the underwater communication techniques. Furthermore, similar techniques may be deployed in an underground mode or indoor mode similar to the underwater mode

Additionally or alternatively, the electronic device may be used to allow the electronic device to communicate one or more short message service (SMS) messages or multimedia message service (MMS) messages via a peer-to-peer (P2P) communication link (e.g., via optical or auditory signaling) in the absence of through-air wireless communications (e.g., a cellular network, an internet network, or any of various other through-air traditional communication networks). In this way, the electronic device may establish P2P communication links with other electronic devices or antenna bases from remote locations enabling a user (e.g., a diver) to communicate with others even without LoS between the communicating parties.

Indeed, although examples of the present embodiments may be discussed primarily with respect to utilizing the electronic device within underwater or underground environments, it should be appreciated that the techniques described herein may also be useful in any of various other applications such as, for example, medical applications (e.g., noninvasive sensing, heart monitoring), security related applications (e.g., surveillance, motion detection), manufacturing and distribution applications (e.g., products manufacturing and products tracking systems), oil and gas exploration related applications (e.g., downhole and subsea environments), energy extraction applications (e.g., coal mines, tunnels, fracking wells, and so forth), aerospace applications (e.g., “airplane mode”), military applications (e.g., Navy SEAL operations), search-and-rescue operations, and the like where through-air wireless communications may be limited.

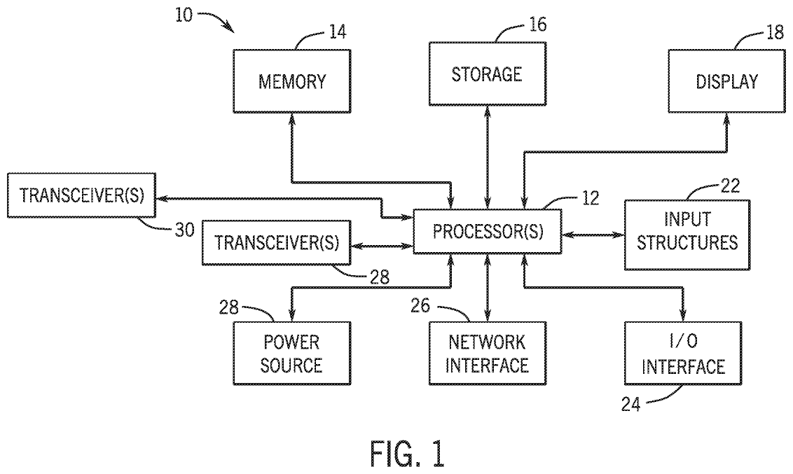

With the foregoing in mind, a general description of suitable electronic devices that may be useful in performing magneto-inductive charging and communication in the absence of a cellular and/or internet network connection will be provided below. Turning first to FIG. 1, an electronic device 10 according to an embodiment of the present disclosure may include, among other things, one or more processor(s) 12, memory 14, nonvolatile storage 16, a display 18, input structures 22, an input/output (I/O) interface 24, network interfaces 26, transceiver(s) 28 for a first type of communication (e.g., radio waves), a power source 29, and transceiver(s) 30 for a second type of communication (e.g., auditory or optical). The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in electronic device 10.

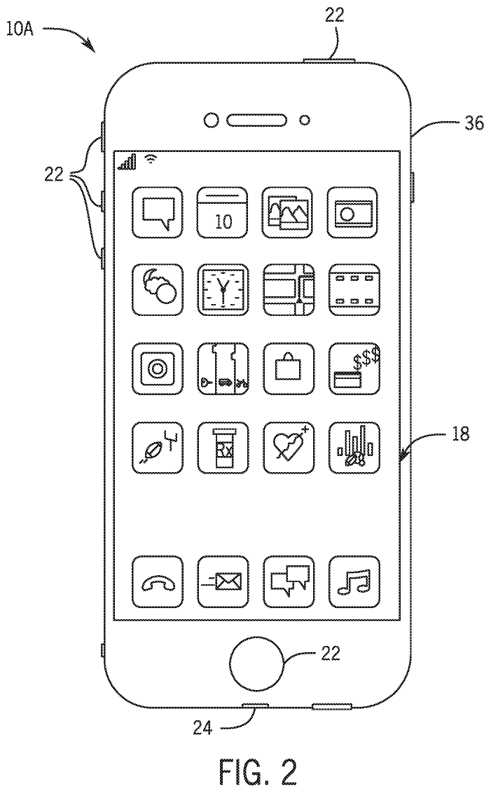

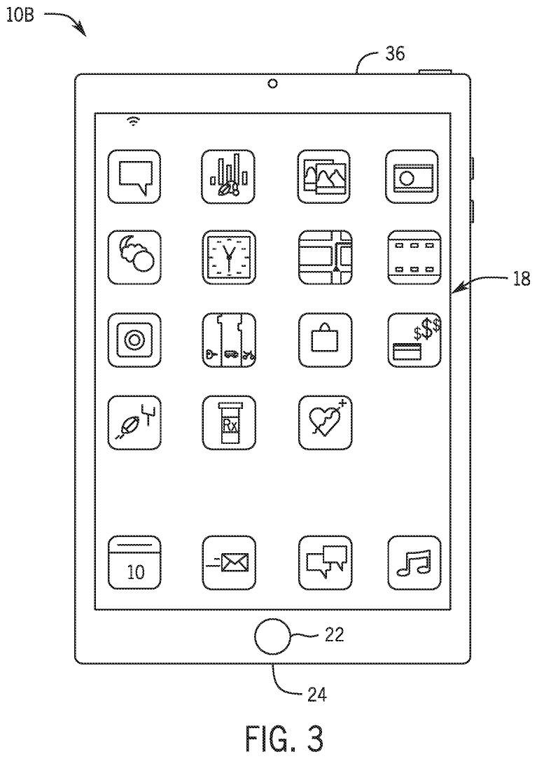

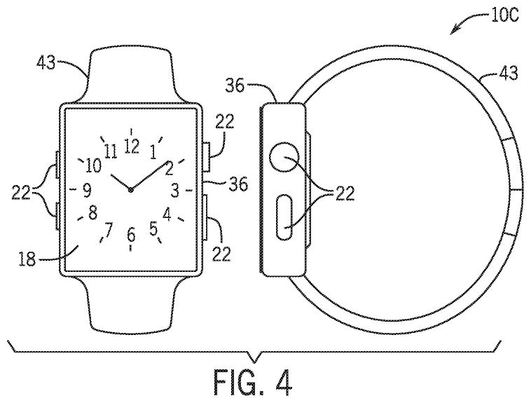

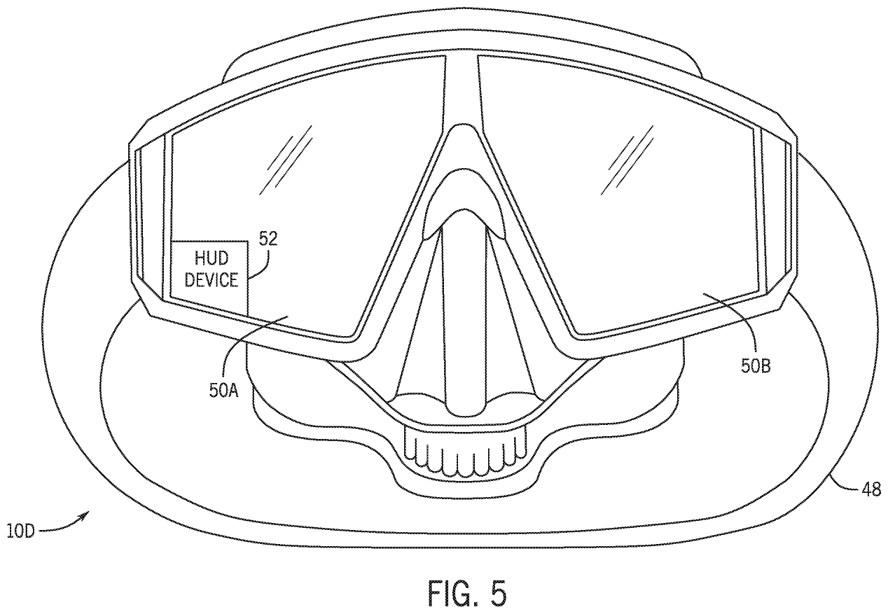

By way of example, the electronic device 10 may represent a block diagram of a handheld device depicted in FIG. 2, a handheld device depicted in FIG. 3, a wearable electronic device depicted in FIG. 4, a wearable electronic device depicted in FIG. 5, or similar devices. It should be noted that the processor(s) 12 and/or other data processing circuitry may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 and/or other data processing circuitry may be operably coupled with the memory 14 and the nonvolatile storage 16 to perform various algorithms. Such programs or instructions executed by the processor(s) 12 may be stored in any suitable article of manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., an operating system) encoded on such a computer program product may also include instructions that may be executed by the processor(s) 12 to enable the electronic device 10 to provide various functionalities.

In certain embodiments, the display 18 may be a liquid crystal display (LCD), which may allow users to view images generated on the electronic device 10. In some embodiments, the display 18 may include a touch screen, which may allow users to interact with a user interface of the electronic device 10. Furthermore, it should be appreciated that, in some embodiments, the display 18 may include one or more organic light emitting diode (OLED) displays, or some combination of LCD panels and OLED panels.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN) or wireless local area network (WLAN), such as an 802.11x Wi-Fi network, and/or for a wide area network (WAN), such as a 3rd generation (3G) cellular network, 4^{th} generation (4G) cellular network, long term evolution (LTE) cellular network, long term evolution license assisted access (LTE-LAA) cellular network, or 5^{th} generation (5G) cellular network. The network interface 26 may also include interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra-Wideband (UWB), alternating current (AC) power lines, and so forth.

In certain embodiments, to allow the electronic device 10 to communicate over the aforementioned wireless networks (e.g., Wi-Fi, WiMAX, mobile WiMAX, 4G, LTE, and so forth), the electronic device 10 may include a transceiver(s) 28. The transceiver(s) 28 may include any circuitry the may be useful in both wirelessly receiving and wirelessly transmitting signals (e.g., data signals). Indeed, in some embodiments, as will be further appreciated, the transceiver(s) 28 may include a transmitter and a receiver combined into a single unit, or, in other embodiments, the transceiver(s) 28 may include a transmitter separate from the receiver.

For example, the transceiver(s) 28 may transmit and receive signals (e.g., data symbols) to support data communication in wireless applications such as, for example, PAN networks (e.g., Bluetooth), WLAN networks (e.g., 802.11x Wi-Fi), WAN networks (e.g., 3G, 4G, and LTE and LTE-LAA cellular networks), WiMAX networks, mobile WiMAX networks, ADSL and VDSL networks, DVB-T and DVB-H networks, UWB networks, and so forth. As further illustrated, the electronic device 10 may include a power source 29. The power source 29 may include any suitable source of power, such as a rechargeable lithium polymer (Li-poly) battery and/or an alternating current (AC) power converter.

In addition to or alternative to the transceiver(s) 28, the electronic device 10 may include transceiver(s) 30 that utilize a wireless communication mechanism other than those utilized by the transceiver(s) 28. For instance, the transceiver(s) 28 may utilize communication methods suited for communication through a first medium (e.g., air) while the transceiver(s) 30 may utilize communication methods suited for communication through a second medium (e.g., water, earth, solids).

For example, the transceiver(s) 30 may include a sound-based transceiver used to send and/or receive ultrasonic or infrasonic sound-based signals that are encoded to communicate messages. As an example, the transceiver(s) 28 may utilize sound navigation ranging (sonar) signals that are encoded for communication. To enable encoding of data, the sound-based signals may include a number and/or duration of pulses that encode the data in a format (e.g., short message service (SMS)) that is mutually understood by both sending and receiving devices.

In addition to or alternative to the sound-based communication, the transceiver(s) 30 may include a light emission element and/or image sensor that is configured to transmit light and/or sense light. For instance, the transceiver(s) 30 may enable the electronic device 10 to emit a color (e.g., green) of light that has a higher transmission capability than wireless communication in some mediums (e.g., water, etc.). The color of light may be pulsed similarly to how sound-based signals above are pulsed to encode message data (e.g., SMS). The transceiver(s) 30 may also include an image sensor that detects light emitted from other transmitters of other devices to enable the electronic device 10 to decode remote communications.

In some embodiments, the transceiver(s) 30 may use a same antenna that is used by the transceiver(s) 28. Alternatively, the transceiver(s) 30, if using an antenna, may utilize different antennas than those used by the transceiver(s) 28.

In certain embodiments, the electronic device 10 may take the form of a portable electronic device, a wearable electronic device, or other type of electronic device. FIG. 2 depicts a front view of a handheld device 10A, which represents one embodiment of the electronic device 10. The handheld device 10B may represent, for example, a portable phone, a media player, a personal data organizer, a handheld game platform, or any combination of such devices. By way of example, the handheld device 10B may be a model of an IPOD® or IPHONE® available from Apple Inc. The handheld device 10B may include an enclosure 36 to protect interior components from physical damage and to shield them from electromagnetic interference. The enclosure 36 may surround the display 18. The I/O interfaces 24 may open through the enclosure 36 and may include, for example, an I/O port for a hard wired connection for charging and/or content manipulation using a standard connector and protocol, such as the Lightning connector provided by Apple Inc., a universal serial bus (USB), or other similar connector and protocol.

The input structures 22, in combination with the display 18, may allow a user to control the handheld device 10B. For example, the input structures 22 may activate or deactivate the handheld device 10B, navigate user interface to a home screen, a user-configurable application screen, and/or activate a voice-recognition feature of the handheld device 10A. Other input structures 22 may provide volume control or may toggle between vibrate and ring modes. The input structures 22 may also include a microphone that may obtain a user's voice for various voice-related features, and a speaker that may enable audio playback and/or certain phone capabilities. The input structures 22 may also include a headphone input that may provide a connection to external speakers and/or headphones.

FIG. 3 depicts a front view of another handheld device 10B, which represents another embodiment of the electronic device 10. The handheld device 10B may represent, for example, a tablet computer, or one of various portable computing devices. By way of example, the handheld device 10B may be a tablet-sized embodiment of the electronic device 10, which may be, for example, a model of an IPAD® available from Apple Inc.

Similarly, FIG. 4 depicts a wearable electronic device 10C representing another embodiment of the electronic device 10 of FIG. 1 that may be configured to operate using the techniques described herein. By way of example, the wearable electronic device 10E, which may include a wristband 43, may be an APPLE WATCH® by Apple Inc. However, in other embodiments, the wearable electronic device 10E may include any wearable electronic device such as, for example, a wearable exercise monitoring device (e.g., pedometer, accelerometer, heart rate monitor) or and/or another wearable accessory that communicates with another electronic device 10 (e.g., the handheld device 10A, the handheld device 10B, or another wearable electronic device 10C). The display 18 of the wearable electronic device 10C may include a touch-screen display 18 (e.g., LCD, OLED display, active-matrix organic light emitting diode (AMOLED) display, and so forth), as well as input structures 22, which may allow users to interact with a user interface of the wearable electronic device 10C.

FIG. 5 depicts another wearable electronic device 10D representing another embodiment of the electronic device 10 of FIG. 1 that may be configured to operate using the techniques described herein. By way of example, the wearable electronic device 10D may include a strap 48 and one or more lenses 50. One or more of the lenses 50 may include a heads-up display (HUD) 52. In the depicted embodiment, the HUD 52 is disposed on a left lens 50A of the wearable electronic device 10D. However, in other embodiments, the HUD 52 may be disposed on a right lens 50B of the wearable electronic device 10D. In yet other embodiments, the HUD 52 may be disposable in either the left lens 50A or the right lens 50B based on the user's preference. The HUD 52 may include an opaque, translucent, transparent, and/or partially transparent display used to present information to the user in addition to what the user may view through the lenses. For example, the HUD 52 may be used to display information about the user's position, an amount of oxygen left in a tank of the user, a rate of oxygen being used, a depth of the user, communications between other users, and/or other information that may be of value to the user during a dive. The HUD 52 may include any suitable display panel technology. For instance, the HUD 52 may utilize a liquid crystal display (LCD), which may allow users to view images generated on the electronic device 10. Furthermore, it should be appreciated that, in some embodiments, the HUD 52 may include one or more organic light emitting diode (OLED) displays, or some combination of LCD panels and OLED panels.

In certain embodiments, the HUD 52 may include an at least partially transparent display panel (e.g., transparent OLED panel). When an at least partially opaque, at least a portion of the user's vision may be occluded by the HUD 52. As illustrated, the HUD 52 may occlude only a small section of the lens 50 (e.g., left lens 50A), while leaving a larger section unobstructed. Accordingly, when compared to larger display systems, the wearer may have an improved situational awareness and field of view useful in open-water diving activities.

As previously discussed, some communication techniques (e.g., cellular, Bluetooth, 802.11, or 802.15 network signals) may be unsuitable for communication in some mediums (e.g., underwater, underground, or any other medium denser than air). For example, such communication techniques may not be conducive for underwater communication due to a dramatic falloff of the signal (e.g., less than 1, 2, 5, or 10 feet) due to water interfering with transmission of the signals. Thus, the transceiver(s) 30 may enable the electronic device 10 to establish one or more peer-to-peer (P2P) communication links with another electronic device or an antenna base (e.g., in a buoy) from remote locations. The P2P communication links may also be enabled in other scenarios where cellular or Wi-Fi communications are unsuitable or unavailable. For instance, the P2P communication links may be used inside of caves or tunnels, at extremely high altitudes, at sea, in “airplane mode”, and/or any location in which a cellular or internet network is unavailable. Furthermore, P2P communication may reduce radio noise in operation when cellular or Wi-Fi networks are available. For example, certain cellular base stations or wireless routers may broadcast signals from one user to the entire service area in order to reach the intended user on the other end. This may be a source of noise to other receivers (users) in that service area. However, the present embodiments may include a sound- or optical-based P2P communication link to reduce cellular and/or Wi-Fi noise at the devices of the network.

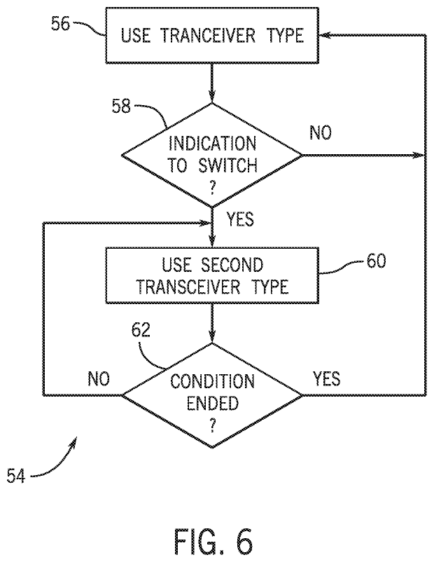

In some embodiments where the electronic device 10 includes both the transceiver(s) 28 and the transceiver(s) 30, the electronic device 10 may use both the transceiver(s) 28 and the transceiver(s) 30 concurrently. Additionally or alternatively, the electronic device 10 may switch between the transceiver(s) 28 and the transceiver(s) 30 for communication. For instance, FIG. 6 illustrates a flow diagram of a process 54 for switching between the transceiver(s) 28 and the transceiver(s) 30. The electronic device 10 uses the transceiver(s) 28 to send and/or receive information (block 56). The electronic device 10 may default to the transceiver(s) 28 or may utilize the transceiver(s) 28 in response to a detected environment or user input. For instance, the electronic device 10 may utilize the transceiver(s) 28 when wireless signals are detected, when an underwater mode is not selected in a user interface, an underwater detection mechanism determines that the electronic device 10 is not underwater, and the like.

The electronic device 10 receives an indication to switch between the transceiver(s) 28 and the transceiver(s) 30 (block 58). The indication may include an indication that electronic device 10 is underwater. For example, the indication may include receiving a manual selection of an underwater mode via an interface. For example, an underwater application may be opened in the electronic device 10 that causes the electronic device 10 to switch to using the transceiver(s) 30. Additionally or alternatively, the indication may include a detection that a pressure has increased in one or more pressure sensors due to submersion and/or an altitude of the electronic device 10 has dropped below sea level (e.g., using a barometer). The electronic device 10 may also include a moisture detector that detects whether the electronic device 10 has been submerged. The electronic device 10 may include other mechanisms for detecting that the electronic device 10 has been submerged, such as camera detection, light sensor detection, or any suitable technique for confirming that the electronic device has been submerged/

The indication may also be related to a lack of cellular signals at the electronic device 10. For example, if connection to all connected wireless networks (e.g., cellular and Wi-Fi networks) are lost, the electronic device 10 may attempt to use the transceiver(s) 30.

Regardless of what initiates the indication to switch, the electronic device 10 may attempt to use the transceiver(s) 30 when sending out at least some types of data (block 60). For instance, the electronic device 10 may still try to use the transceiver(s) 28 for some purposes (e.g., global positioning, voice communications) while using the transceiver(s) 30 for other communication types (e.g., SMS). In certain embodiments (e.g., when a user has selected underwater mode), the transceiver(s) 28 may be disabled for at least some of these communication types. Alternatively, the electronic device 10 may attempt to send some communication types (e.g., SMS) through both the transceiver(s) 28 and the transceiver(s) 30. At some point, the electronic device 10 receives an indication that the condition causing the indication has ended (block 62) and returns to operation using the transceiver(s) 28 in block 56.

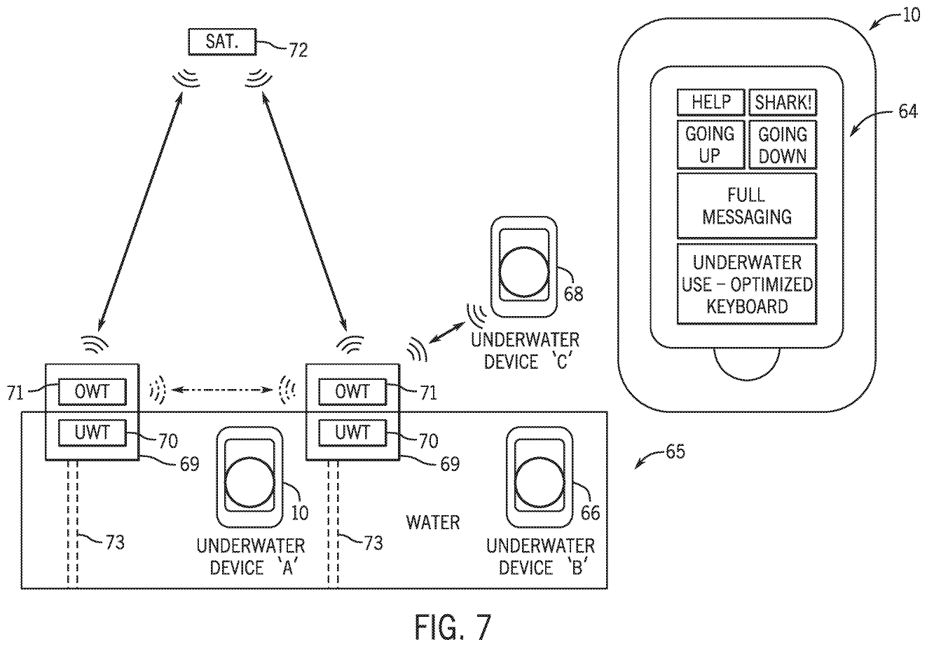

In certain embodiments, as depicted in FIG. 7, the electronic device 10 may be used to communicate in underwater environments. For example, as illustrated, the electronic device 10 (e.g., “underwater device A”) may be located in an underwater environment 65. Another electronic device 66 (e.g., “underwater device B”) may also be located within the underwater environment 65, while a third electronic device 68 (e.g., “surface device C”) may be located above water. In certain embodiments, utilizing the transceiver(s) 30, the electronic device 10 may wirelessly communicate (e.g., via ultrasonic and/or infrasonic sound signals, optical signals, and the like) one or more messages (e.g., SMS, MMS) to the electronic device 66. The electronic device 66 that is underwater may then communicate the one or more messages to the electronic device 68 that above the water.

In some embodiments, an edge device 69 may be located at the surface of the underwater environment 65. The edge device 69 may include at least some of the components or more components (e.g., flotation structure) than those discussed in relation to the electronic device 10 in FIG. 1. For instance, the edge device 69 may include a buoy that includes a floating apparatus that causes the edge device 69 to float at the surface of the water. The edge device 69, located at the edge of the underwater environment 65, may communicate with devices (e.g., the electronic device 10 or the electronic device 66) in the underwater environment 65 using underwater transceiver(s) (UWT) 70 that may correspond to a transceiver type of the transceiver(s) 30 that is conducive to underwater communication. As may be appreciated, the edge device 69 may be relatively larger than the electronic device 10 with additional processing, transmitting power, and/or stored power availability. In other words, the edge device 69 may be capable of broadcasting messages further than the electronic device 10 is capable. In some embodiments, the edge device 69 may also use more processing (e.g., filtering and analysis) to received signals that may be indistinguishable from noise for the electronic device 10. Furthermore, the edge device 69 may have extra receivers or more sensitive receivers (e.g., microphones, image sensors, etc.) that may detect incoming signals that the electronic device 10 may be incapable of detecting. Accordingly, the edge device 69 may be capable of detecting and decoding signals from further away than from which the electronic device 10 is capable of detecting and/or decoding.

The edge device 69 may act as a hub for communications between electronic device 10 and the electronic device 66 for underwater communications. This interconnection function of the edge device 69 may enable the electronic device 10 to extend its communication length beyond its own range using a repeating function of the edge device 69.

Furthermore, the edge device 69 may include out-of-water transceiver(s) (OWT) 71 that enable the edge device 69 to communicate with the electronic device 68 using through-the-air wireless signals, such as cellular signals, Wi-Fi signals, 802.15 signals, and the like. Additionally or alternatively, the edge device 69 may communicate with a satellite 72. Furthermore, in embodiments where the edge device 69 is implemented as a buoy, the anchor may include or be accompanied by a wired connection 73 that may be used to communicate between the edge devices 69 and/or a remote system (e.g., cloud). The remote device and/or the satellite 72 may be used to track a location of the diver with the electronic device 10 in real time or near-real time. For instance, the location of the diver having the electronic device 10 may be tracked as the location of the edge device 69 in contact with the electronic device 10. For instance, as previously discussed, the edge device 69 communicate with one or more satellites (e.g., satellite 72). The edge device 69 may acquire a GPS location using the satellite 72 or another satellite to which it is connected.

The location of the electronic device 10 may be tracked more closely when the electronic device connects to more than a single edge device 69. For instance, the edge devices 69, the satellite 72, and/or a remote computing system (e.g., cloud) may acquire locations of a number (e.g., 3) of edge devices 69 along with a direction, a time-of-flight, and/or a signal strength of signals received from the electronic device 10. Using the locations of the edge devices 69 and the direction/signal strength/time-of-flight of the signals, the location of the electronic device 10 may be more precisely ascertained using triangulation.

Using the UWT 70, the OWT 71, and/or the wired connection 73, the edge devices 69 may provide a mesh network to which the electronic devices 10, 66, and/or 68 may connect. For example, the edge devices 69 may connect to each other using wireless connections directly between the edge devices via the UWT 70 and/or the OWT 71, wireless connections via the satellite 72, and/or the wired connections via the wired connections 73. Using the edge-to-edge connections between edge devices 69, communications between the electronic device 10 and the electronic device 66 may be extended over much greater distances than possible using a direct connection between the electronic device 10 and the electronic device 66 even when boosted by a single edge device 69 acting as an intermediary.

In certain embodiments, as further depicted in FIG. 7, the electronic device 10 may launch a software application 64 (e.g., app) in the inductive communication configuration. For example, in some embodiments, the software application 64 may include an application conducive to underwater usage, and may include, for example, a look-up table (LUT) of predetermined key messages and special keyboard features (e.g., enlarged buttons, character rolls, and so forth). As previously noted, opening this software application 64 may cause the electronic device 10 to begin attempting to use the transceiver(s) 30 to perform underwater communication.

In certain embodiments, the predetermined messages may include, but may not be limited to, “Help!”, “Here!”, “Going up!”, “Going down!”, “Shark!”, or any of various other predetermined SMS messages that may indicate pertinent information in the most efficient manner. In some embodiments, the predetermined SMS messages may be user-customizable and may include specific user identification (ID) signatures. Further, in some embodiments, multiple sets of predetermined SMS messages may be stored in the electronic device 10 with a selection of a type of activity (e.g., rescue dive, recreation, etc.) causing a corresponding set of predetermined SMS messages to be displayed on the electronic device 10.

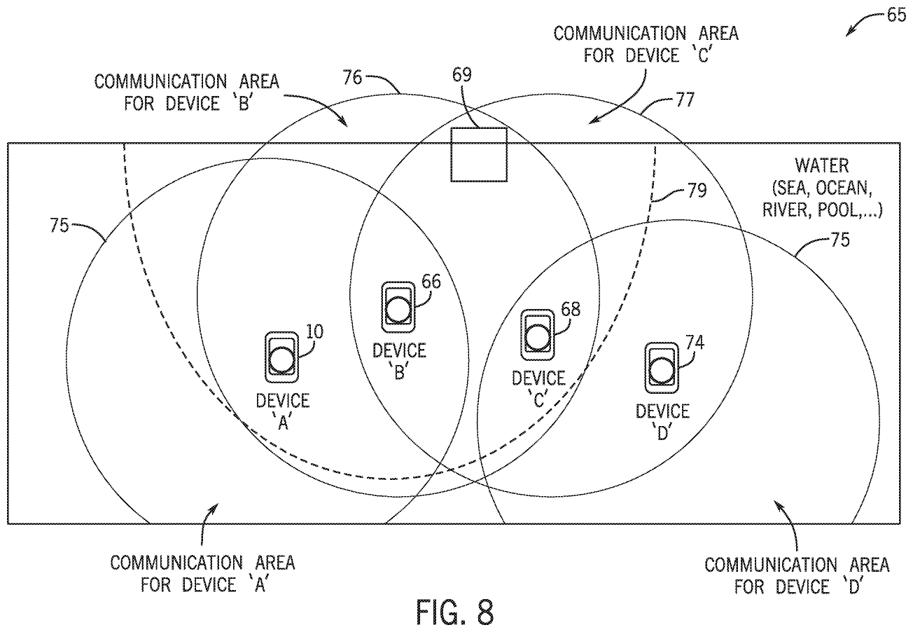

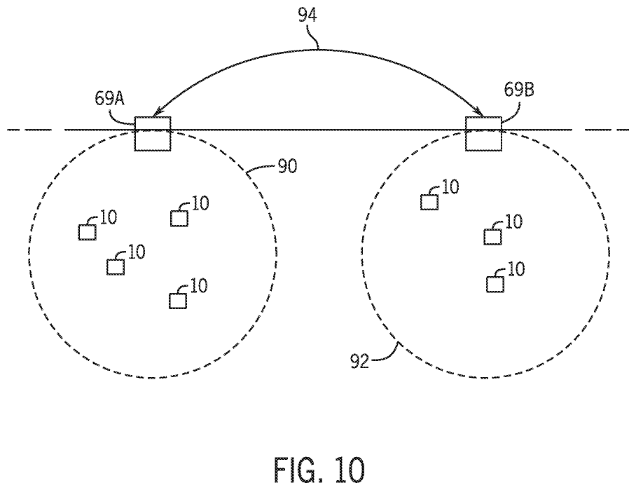

In certain embodiments, as depicted in FIG. 8, the electronic device 10 may be one of a number of electronic devices that may be located within the underwater environment 65 (e.g., sea, ocean, river, pool). As illustrated by FIG. 10, for a number of electronic devices 10 (e.g., “underwater device A”), 66 (e.g., “underwater device B”), 68 (e.g., “underwater device C”), and 74 (e.g., “underwater device D”) that may be distributed across large underwater area, the electronic devices 10, 66, 68, and 74 may form a message re-broadcast network that may be utilized to increase communication range.

For example, as illustrated by FIG. 8, each of the electronic devices 10, 66, 68, and 74 may form a respective a communication coverage area 75, 76, 77, and 78. In such an embodiment, messages may be successively rebroadcast via a communication path of, for example, electronic device 10 to electronic device 66 to electronic device 68 to electronic device 74 (e.g., quasi-mesh network). In this way, the transceiver(s) 30 may allow the electronic device 10, for example, to communicate messages to, and receive messages from, for example, the electronic device 74, even though the electronic device 10 and the electronic device 74 may be out of range with one another. Furthermore, the edge device 69 may use the mesh-nature of the communications between the electronic devices 68 and 74 to communicate with the electronic device 74 via the electronic device 68 acting as a relay of messages even though the electronic device 74 may be outside of a range 79 of the edge device 69.

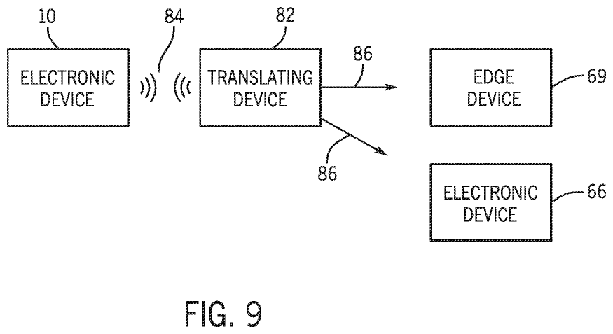

In some embodiments, the electronic device 10 may be a specialized dive version of a model of the electronic device 10, such as a dive version of a watch, mask, mobile telephone, or a tablet, that may include the transceiver(s) 30 suitable for underwater communication. However, in some embodiments, the electronic device 10 may not have the transceiver(s) 30 internal to the electronic device 10. Instead, the electronic device 10 may utilize the transmissibility of air-based communication messages over a relatively short distance (e.g., less than 6 inched, less than 1 foot, or less than 2 feet) in water. Thus, in some embodiments such as the one illustrated in FIG. 9, the electronic device 10 may use an external translating device 82 to translate messages to the edge device 69 and/or the electronic device 66 from the electronic device 10. Messages from the electronic device 10 may use available (e.g., through-air) wireless communication 84 available in the electronic device 10 but may be capable of transmission only over a short distance (e.g., less than 2 inches or less than 2 feet) in water. The available wireless communications 84 may include transmitting information via 802.15, 802.11, cellular, and/or optical signals from an LED (e.g., green LED) and/or the display 18. The translating device 82 may include any of the embodiments and/or any of the components previously discussed in relation to the electronic device 10. As an example, the electronic device 10 and the translating device 82 may both be watches worn on the same arm to ensure that a short distance exists between the electronic device 10 and the translating device 82. Additionally or alternatively, the electronic device 10 and/or the translating device 82 may include a device located on the diver in a pocket or attached to the diver. As illustrated, the translating device 82 may convert messages in the available wireless communications 84 to underwater communications 86 and may transmit the underwater communications 86 to the edge device 69 and or to the electronic device 66.

In some embodiments, when the indication that the electronic device 10 is submerged, such as those discussed in relation to block 58 of FIG. 6, the electronic device 10 may switch from attempting to use the transceiver(s) 28 to reach cell towers, longer-range Bluetooth devices, or 802 protocol-based access points to instead direct messages toward the translating device 82. For instance, the electronic device 10 may be paired (e.g., Bluetooth pairing) prior to a dive with the communication between the electronic device 10 and the translating device 82 becoming the actively used communication channel once the electronic device 10 is detected to have been submerged.

As previously discussed, the edge devices 69 may extend communication between electronic devices 10 that are in the underwater environment 65. Using such intermediary techniques, the edge device 69 may be used to extend communications between two or more groups using their respective edge devices 69. For instance, FIG. 10 illustrates a first group 90 of electronic devices 10 (and respective divers) and a second group 92 of electronic devices 10 (and respective divers). Each group may connect to one or more respective edge devices 69. For instance, the first group 90 may have a connection between the edge device 69A and at least one of the respective electronic devices 10 of the first group 90, and the second group 92 may have a connection between the edge device 69B and at least one of the respective electronic devices 10 of the second group 92. The edge device 69A and the edge device 69B utilize an edge-to-edge connection 94. The edge-to-edge connection 94 may utilize UWT 70, OWT 71, and/or wired connections 73. The edge-to-edge connection 94 may include a direct connection between the edge device 69A and the edge device 69B. Alternatively, the edge-to-edge connection 94 may include one or more hops via other edge devices 69, electronic devices 10, the satellite 72, a remote computing system (e.g., cloud), and/or other interconnecting devices.

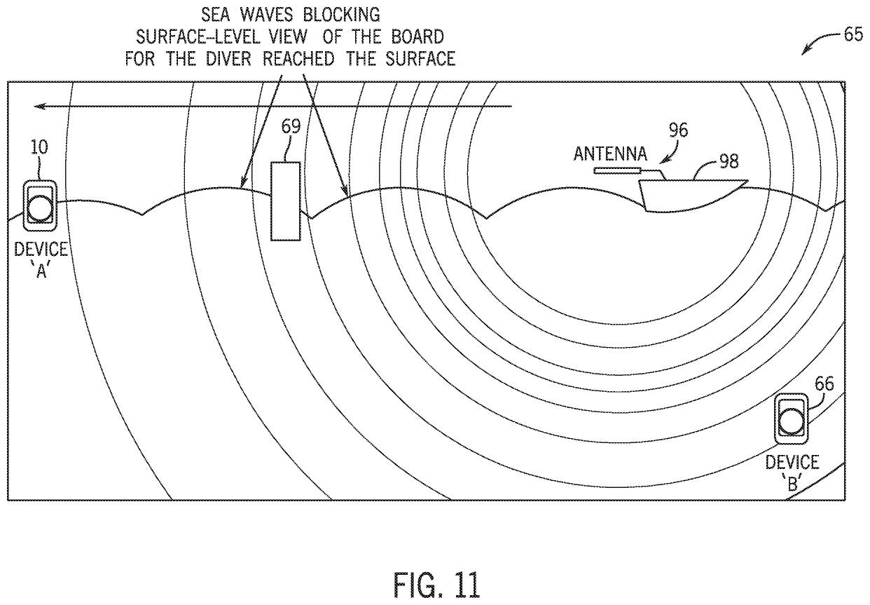

FIG. 11 illustrates another example embodiment of the presently disclosed techniques, in which antenna(s) 96 may be placed on a sea vessel 98 (e.g., boat or ship) and operate as a communication beacon on the surface for, for example, divers that may be within the underwater environment 65. For example, as further depicted, in one embodiment, the antenna(s) 96 may extend from the sea vessel 98 into the open air. Additionally or alternatively, the antenna(s) 96 may be submerged within underwater environment 65 underneath and/or behind the sea vessel 98.

During such times, the software application 64 may be used to initiate a return-to-home mode indicating that the diver is to return to the sea vessel 98. The return-to-home mode may be initiated using a selection of a corresponding button in the software application 64. In some embodiments, the return-to-home mode may cause the transceiver(s) 30 to operate in a receive-only mode to indicate, for example, a received signal strength indication (RSSI) of the communication beacon signal generated by the antenna(s) 96. For example, in this way, a user of the electronic device 10 may rotate or move underwater and/or on the surface of the water while observing RSSI increasing or decreasing, which would thus indicate the direction in which the sea vessel 98 is moving. For example, if the RSSI decreases that diver and the sea vessel 98 may be becoming further apart.

In certain embodiments, the antenna(s) 96 on the sea vessel 98 may be powered from a high-power source on the sea vessel 98, and may thus be useful in achieving large underwater communication coverage such that communication beacon signal may be detected by the electronic device 10 and the deeply submerged electronic device 66 (e.g., “underwater device B”). In some embodiments, the antenna(s) 96 of the sea vessel 98 may be a single-loop, fixed orientation antenna, or, in another embodiment, may include a number of loops positioned in orthogonal orientations and may operate at the same frequency or at different frequencies. In some embodiments, the electronic device 10 may include software that may be useful in correlating the different frequencies and RSSI values to the specific positioning of the antenna(s) 96 to increase direction detection accuracy. Even with the high-power source on the sea vessel 98, currents may cause a diver to drift beyond the range of the antenna(s) 96. In such situations, an edge device 69 may extend the range of detection of the antenna(s) 96 by acting as an intermediary and/or signal repeater. For instance, the edge device 69 may communicate with the antenna(s) 96 using through-the-air and/or through-the-water communication mechanisms discussed herein. The edge device 69 may forward communications to the electronic device 10 via underwater communication techniques.

As previously discussed, the electronic device 10 may be used as a communication beacon in location-critical operations (e.g., search and rescue operations). For example, the electronic device 10 may include a search-and-rescue-related software application that is included in the software application 64 and/or separate from the software application 64. The search-and-rescue-related software application may allow a user to send an SMS message as to her whereabouts and safety conditions. The electronic device 10 may also be able to provide location data (e.g., location of an edge device 69 and/or a triangulated location), SMS and MMS messages, and so forth from any location in which a cellular or internet is unavailable. In this way, the present embodiments, may facilitate search and rescue operations.

The electronic device 10 may maintain one or more conversations conducted using the transceiver(s) 30. For instance, the different conversations may utilize different frequency bands. The electronic device 10 may assign the conversations to the frequency bands (i.e., similar to a two-way radio transceiver or “walkie-talkie”). Additionally or alternatively, the edge device 69 to which the electronic device 10 is connected may assign the frequency bands for different conversations. Messages in the corresponding frequency band may be assigned for a conversation by the electronic device 10.

Additionally or alternatively, each message (e.g., SMS) may be appended with a prefix at the beginning of the message and/or a suffix at the end of the message identifying the conversations. For instance, the conversation field may have an encoded field with a number identifying the conversation. Additionally or alternatively, the message may be indicated with additional information, such an indication of whether the message is to be repeated locally (e.g., within the first group 90), repeated across multiple edge devices 69, delivered to a target edge device 69, shared with the satellite 72 and/or a remote system (e.g., cloud), and the like. In some embodiments, the additional information may identify a target electronic device or a diver using the electronic device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An underwater communication system, comprising:
a first wireless transceiver configured to transmit first wireless signals through an air medium, wherein the first wireless signals are not conducive for transmission through water;
a second wireless transceiver configured to transmit second wireless signals through water, wherein the second wireless signals comprise audio-based signals conducive for transmission through water;
memory storing instructions; and
a processor configured to execute the instructions to cause the processor to:
detect that an electronic device having the first wireless transceiver has been submerged; and
transmit at least some communication types from the second wireless transceiver based at least in part on the detection that the electronic device has been submerged.

2. The underwater communication system of claim 1, wherein the audio-based signals comprise ultrasonic or infrasonic signals.

3. The underwater communication system of claim 1, wherein the second wireless transceiver is located inside the electronic device.

4. The underwater communication system of claim 1, comprising a second electronic device different than the electronic device, wherein the second electronic device comprises the second wireless transceiver.

5. The underwater communication system of claim 4, wherein the second electronic device comprises a third wireless transceiver configured to receive the first wireless signals from the first wireless transceiver.

6. The underwater communication system of claim 5, wherein the audio-based signals comprise ultrasonic signals.

7. The underwater communication system of claim 1, wherein the first wireless signals comprise cellular-based signals, 802.15-based signals, or 802.11-based signals.

8. The underwater communication system of claim 1, wherein detecting that the electronic device is submerged comprises receiving a manual selection of a submerged status.

9. The underwater communication system of claim 1, wherein detecting that the electronic device is submerged comprises receiving an increase in moisture readings from a moisture sensor.

10. The underwater communication system of claim 1, wherein detecting that the electronic device is submerged comprises receiving an increase in pressure readings from a pressure sensor.

11. The underwater communication system of claim 1, wherein the at least some communication types comprise short message service (SMS) communication.

12. The underwater communication system of claim 1, wherein the instructions, when executed, are configured to cause the processor to disable the first wireless transceiver based at least in part on detecting that the electronic device is submerged.

13. A method, comprising:
transmitting first messages in first protocol wireless signals to a base station or access point;
determining that an electronic device has been submerged; and
based at least in part on the determination that the electronic device has been submerged, transmitting second messages to a translating device instead of the base station or access point, wherein the translating device is configured to transmit the second messages using second protocol wireless signals.

14. The method of claim 13, wherein the first protocol wireless signals comprise cellular signals, 802.11 signals, or 802.15 signals.

15. The method of claim 13, wherein the second protocol wireless signals comprise sound-based wireless signals.

16. The method of claim 15, wherein the sound-based wireless signals comprise ultrasonic wireless signals comprising pulses of ultrasonic sounds to encode the second messages.

17. A surface wireless electronic device, comprising:
a flotation apparatus configured to position the wireless electronic device at a surface of water;
an underwater transceiver configured to receive a message through the water from an electronic device of a diver; and
an out-of-water transceiver configured to transmit the message to another surface wireless electronic device through air to cause the other surface wireless electronic device to forward the message through the water to another electronic device of another diver.

18. The surface wireless electronic device of claim 17, comprising an anchored buoy.

19. The surface wireless electronic device of claim 18, wherein the out-of-water transceiver comprises a wired connection transmitted along an anchor of the anchored buoy.

20. The surface wireless electronic device of claim 17, wherein the out-of-water transceiver comprises a satellite transceiver configured to transmit the message to a satellite that forwards the message to the other wireless electronic device.
